(19) United States
(12) Patent Application Publication
(10) Pub. No.: US 2021/0097512 A1
(43) Pub. Date: Apr. 1, 2021

(54) METHODS AND SYSTEMS FOR CLASSIFYING PAYMENT TRANSACTIONS

(71) Applicant: MASTERCARD INTERNATIONAL INCORPORATED, Purchase, NY (US)

(72) Inventors: Ahmed ElMeadawy, Dubai (AE); Dina Kahiel, Dubai (AE); Sait Halici, Dubai (AE); Konstantin Abramov, Moscow (RU); Khaled Mahdy, Cairo (EG)

(21) Appl. No.: 17/024,622

(22) Filed: Sep. 17, 2020

(30) Foreign Application Priority Data
Sep. 30, 2019 (SG) 10201909132V

(51) Int. Cl. G06Q 20/10; G06N 20/00; G06K 9/62; G06F 3/0488

(52) U.S. Cl. CPC G06Q 20/102; G06F 3/0488; G06K 9/6267; G06N 20/00

(57) ABSTRACT

Embodiments provide methods and systems for classifying payment transactions. The method includes determining, by a server system, an occurrence of a payment transaction performed by a user. The method includes sending, by the server system, a notification of the payment transaction to a user device associated with the user. The method includes receiving, by the server system, a user input in response to the notification. The method further includes classifying, by the server system, the payment transaction into one of a personal transaction and a business transaction based on the user input. Furthermore, the classification of the payment transactions may be performed independent of the user input by learning a pattern of classification of the classified payment transactions. The pattern may be used to classify future payment transactions. A segregated transaction statement and customized plans may be provided to the user based on the classified transaction.

### CLAIM OF FOREIGN PRIORITY

The present application for patents claims priority to Singapore Patent Application number SG 10201909132V, filed Sep. 30, 2019, and which is incorporated by reference hereto, and which also assigned to assignee hereof.

### TECHNICAL FIELD

The present disclosure relates to payment transactions and, more particularly to, methods and systems for classifying payment transactions.

### BACKGROUND

Typically, owners of small or medium enterprises (SMEs) may use personal payment cards for purchasing goods/services. The personal payment cards may include a credit card, a debit card, and the like. The goods/services purchased may be related to the personal expenses of the owners or to the business expenses for the SMEs. In most cases, the SME owners may be unaware of the benefits of using a business payment card for the business expenses. Sometimes, SME owners are content with their personal cards and feel that their personal cards work just fine. In such cases, the owners may use the same personal payment card for both the personal and the business expenses. Such usage of the personal payment cards for payment transactions of the personal or the business expenses, is not only common in the developing countries, but also in the developed countries.

Generally, issuers provide customized business/commercial cards for specific SME segments including but not limited to tradesmen, retail, professional services and manufacturing. These cards have customized benefit plans of different categories that are not all available on personal cards. For instance, the issuer may provide corporate discounts to the user for business expenses. However, the SME owners may miss the opportunity of availing the offers if personal payment cards are used for both the personal and the business expenses. Moreover, the issuer may be unable to identify the type of expenses. This may prevent the issuer to provide suitable plans to the owners based on the expenses. Consequently, revenue and reputation of the issuer may be affected. Also, the issuer may lose customers as the owners may switch to other issuers who provide better plans.

More importantly, when SME owners use their personal cards for their business expenses, it becomes very difficult for them to segregate them later on as the issuers only issue one statement per card. It is crucial to separate personal and business spends to clearly track expenses, file for tax and create standalone financial statements for the business. The time and effort taken to segregate personal and business expenses, is better utilized by the SME owner to focus on their business.

Accordingly, there is a need to overcome the above-mentioned problems and facilitate a technique where payment transactions may be organized in an efficient manner while precluding manual intervention. Additionally, there is a need to enable the issuers to provide plans corresponding to different types of SMEs, through clearly distinguishing spends of the SMEs.

### SUMMARY

Various embodiments of the present disclosure provide methods and systems for classifying payment transactions.

In an embodiment, a method is disclosed. The method includes determining, by a server system, an occurrence of a payment transaction performed by a user. The method includes sending, by the server system, a notification of the payment transaction to a user device associated with the user. The method includes receiving, by the server system, a user input in response to the notification. The method further includes upon receiving the user input, by the server system, classifying the payment transaction into one of a personal transaction or a business transaction.

In another embodiment, a server system is disclosed. The server system includes a memory storing executable instructions and a processor in operative communication with the memory. The processor is configured to execute the instructions to cause the server system to perform a method. The method includes determining, by the server system, an occurrence of a payment transaction performed by a user. The method includes sending, by the server system, a notification of the payment transaction to a user device associated with the user. The method includes receiving, by the server system, a user input in response to the notification. The method includes classifying, by the server system, the payment transaction into one of a personal transaction or a business transaction upon receiving the user input.

In yet another embodiment, another method for classifying a payment transaction is disclosed. The method includes determining, by a server system, an occurrence of a payment transaction performed by a user. The method includes sending, by the server system, a notification of the payment transaction to a user device associated with the user. The method includes receiving, by the server system, a user input in response to the notification. The method includes determining, by the server system, whether the user input is a first gesture input or a second gesture input. The method includes performing, by the server system, one of: upon determining the user input as the first gesture input, classifying the payment transaction into a personal transaction; and upon determining the user input as the second gesture input, classifying the payment transaction into a business transaction. The method includes learning, by the server system, a pattern of classification of payment transactions based on a pre-defined number of classified payment transactions. A future payment transaction is classified independent of the user input based on the pattern. The method includes sending, by the server system, the classified payment transactions to an issuer of the user. Further, the method includes receiving, by the server system, a segregated transaction statement for at least one of the personal transaction or the business transaction based on the classification. Thereafter, the method includes sending, by the server system, the segregated transaction statement to the user device.

Other aspects and example embodiments are provided in the drawings and the detailed description that follows.

### BRIEF DESCRIPTION OF THE FIGURES

For a more complete understanding of example embodiments of the present technology, reference is now made to the following descriptions taken in connection with the accompanying drawings in which:

FIG. 1 illustrates an example representation of an environment in which at least some example embodiments of the present disclosure can be implemented;

FIG. 2 represents a sequence flow diagram of classifying a payment transaction, in accordance with an example embodiment of the present disclosure;

FIG. 3 represents a flowchart diagram for classifying payment transactions, in accordance with an example embodiment of the present disclosure;

FIG. 4A shows an example representation of a user interface (UI) displayed on a user device displaying a notification of payment transaction in a payment application, in accordance with an example embodiment of the present disclosure;

FIG. 4B shows an example representation of a UI displayed on the user device displaying a plug-in in the payment application, in accordance with an example embodiment of the present disclosure;

FIG. 4C shows an example representation of a UI displayed on the user device displaying swiping of the notification to left side, in accordance with an example embodiment of the present disclosure;

FIG. 4D shows an example representation of a UI displayed on the user device displaying swiping of the notification to right side, in accordance with an example embodiment of the present disclosure;

FIG. 5A shows an example representation of a UI displayed on the user device displaying a segregated transaction statement of all payment transactions, in accordance with an example embodiment of the present disclosure;

FIG. 5B shows an example representation of a UI displayed on the user device displaying a segregated transaction statement of personal transactions, in accordance with an example embodiment of the present disclosure;

FIG. 5C shows an example representation of a UI displayed on the user device displaying a segregated transaction statement of business transactions, in accordance with an example embodiment of the present disclosure;

FIG. 6A is an example representation of a format of a transaction file corresponding to a classified payment transaction sent to an issuer server, in accordance with an example embodiment of the present disclosure;

FIG. 6B is another example representation of a format of a transaction file corresponding to a classified payment transaction sent to the issuer server, in accordance with another example embodiment of the present disclosure;

FIG. 7 shows a table representing classified payment transactions and customized plans for the user, in accordance with an example embodiment of the present disclosure;

FIG. 8A illustrates a flow diagram depicting a method for classifying payment transactions, in accordance with an example embodiment of the present disclosure;

FIG. 8B illustrates a flow diagram depicting another method for classifying payment transactions, in accordance with another example embodiment of the present disclosure;

FIG. 9 is a simplified block diagram of a server system for classifying payment transactions into one of a personal transaction and a business transaction, in accordance with an embodiment of the present disclosure;

FIG. 10 is a simplified block diagram of a payment server for classifying payment transactions into one of a personal transaction and a business transaction, in accordance with an example embodiment of the present disclosure;

FIG. 11 is a simplified block diagram of an issuer server used for facilitating payment transactions of users, in accordance with an example embodiment of the present disclosure; and

FIG. 12 shows simplified block diagram of an electronic device, for example, a mobile phone capable of implementing the various embodiments of the present disclosure.

The drawings referred to in this description are not to be understood as being drawn to scale except if specifically noted, and such drawings are only exemplary in nature.

### DETAILED DESCRIPTION

In the following description, for purposes of explanation, numerous specific details are set forth in order to provide a thorough understanding of the present disclosure. It will be apparent, however, to one skilled in the art that the present disclosure can be practiced without these specific details.

Reference in this specification to “one embodiment” or “an embodiment” means that a particular feature, structure, or characteristic described in connection with the embodiment is included in at least one embodiment of the present disclosure. The appearance of the phrase “in an embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

Moreover, although the following description contains many specifics for the purposes of illustration, anyone skilled in the art will appreciate that many variations and/or alterations to said details are within the scope of the present disclosure. Similarly, although many of the features of the present disclosure are described in terms of each other, or in conjunction with each other, one skilled in the art will appreciate that many of these features can be provided independently of other features. Accordingly, this description of the present disclosure is set forth without any loss of generality to, and without imposing limitations upon, the present disclosure.

The term “payment account” used throughout the description refers to a financial account that is used to fund the financial transaction (interchangeably referred to as “payment transaction”). Examples of the payment account include, but are not limited to a savings account, a credit account, a checking account and a virtual payment account. The payment account may be associated with an entity such as an individual person, a family, a commercial entity, a company, a corporation, a governmental entity, a non-profit organization and the like. In some scenarios, a payment account may be a virtual or temporary payment account that can be mapped or linked to a primary payment account, such as those accounts managed by PayPal®, and the like.

The term “payment card”, used throughout the description, refers to a physical or virtual card linked with a financial or payment account that may be presented to a merchant or any such facility in order to fund a financial transaction via the associated payment account. Examples of the payment card include, but are not limited to, debit cards, credit cards, prepaid cards, virtual payment numbers, virtual card numbers, forex cards, charge cards and stored-value cards. A payment card may be a physical card that may be presented to the merchant for funding the payment. Alternatively or additionally, the payment card may be embodied in form of data stored in a user device, where the data is associated with payment account such that the data can be used to process the financial transaction between the payment account and a merchant's financial account.

Overview

Various example embodiments of the present disclosure provide methods and systems for classifying payment transactions. More specifically, techniques disclosed herein enable classification of payment transactions into one of a personal transaction or a business transaction. The classified payment transactions enable organization of the payment transactions without any human intervention. Further, the techniques disclosed allow generation of segregated transaction statements and customized plans for users based on the classified payment transactions.

In many example scenarios, a user owning at least an enterprise, such as an SME may use a personal payment card for purchasing goods/services. The personal payment card may include a debit card, a prepaid card, an e-wallet, a virtual payment card or a credit card that may be used for purchases related to personal expenses, business expenses, or some other type of expenses. The user may perform a payment transaction using a payment application in a user device associated with the user. The term payment application referred herein is a bank application hosted by an issuer of the user and may be interchangeably used as “bank application” throughout the description. It must be noted that there may be various ways of performing the payment transaction, for example, but not limited to, payment transaction at a merchant terminal such as a Point-of-Sale (POS), or payment at an online merchant site. For instance, the user may purchase goods from a departmental store. A payment transaction for the purchased goods may be performed by swiping the payment card at a POS terminal of the departmental store or by entering payment card details on a payment interface of the online merchant site. In some cases, recurring payment transactions are initiated by merchants that store payment card details.

A payment transaction request is sent to a payment server. The payment server transfers the payment transaction request to the issuer. The issuer performs a payment authorization for the payment transaction. A payment amount for the purchased goods is debited from a payment account of the user, upon successful payment authorization. Upon successful authorization of the payment, the payment server determines an occurrence of the payment transaction. The payment server then sends a notification of the payment transaction to the user device. In an illustrative example scenario, the notification may be received in the payment application.

The payment application may include a plug-in module to accept a user input. The plug-in module may be provided by the payment server that can be added as a plug-in in the payment application. When the user receives the notification, the plug-in module may be triggered to receive the user input in response to the notification. The user input may include, but not limited to, a touch input, a gesture input, a voice input and/or the like. In an example embodiment, the user input may include swiping the notification using one of a first gesture or a second gesture, which are different. In an example, the first gesture corresponds to a left side swipe and the second gesture corresponds to a right side swipe, or vice versa. In another example, the first gesture corresponds to an upward swipe and the second gesture corresponds to a downward swipe, or vice versa. In other examples, the first gesture and the second gestures can be any other pre-defined directions on a screen of the user device, opposite to each other. Each of the first and second gestures is tied to an action. For example, in a non-limiting manner, the user swipes the notification on the user device using the first gesture (i.e. a left side swipe) for classifying the payment transaction to a business transaction, and swipes the notification on the user device using the second gesture (i.e. a right side swipe) for classifying the payment transaction to a personal transaction. The present disclosure is explained by taking example of left side swipe as the first gesture and the right side swipe as the second gesture, and these examples should not be considered as limiting to the scope of the present disclosure.

It shall be noted that the user input may be provided at the time of receiving the notification. In case the user misses to provide the user input at the time of receiving the notification, then the user may access the notification in the payment application and swipe the notification to the left side or the right side depending on type of payment transaction.

The user input is sent to the payment server through the plug-in module in the payment application. The payment server classifies the payment transaction based on the user input. In at least an example embodiment, the payment server may classify the payment transaction into one of a personal transaction or a business transaction based on the user input. For instance, the payment server may classify the payment transaction as personal transaction based on swiping of the notification to the left side by the user. The payment transaction may classify the payment transaction as business transaction based on swiping of the notification to the right side by the user.

Furthermore, the payment transactions may be classified into one of the personal transaction or the business transaction in an automated manner by using machine learning techniques. The machine learning techniques may be used to learn a pattern of classification of the payment transactions. The pattern of classification may be learnt based on a pre-defined number of classified payment transactions. The pattern may then be used to classify future payment transactions independent of the user input. The classified payment transaction may be sent to the issuer. The issuer may generate a segregated transaction statement based on the classified payment transaction. The classified payment transaction may be analyzed by the issuer to generate one or more customized plans for the user. Moreover, the user may share the segregated transaction statement to other third-parties for purposes, such as tax evaluation, accounting, etc. The segregated transaction statement may be shared in a file format such as, a pdf, a csv, or the like.

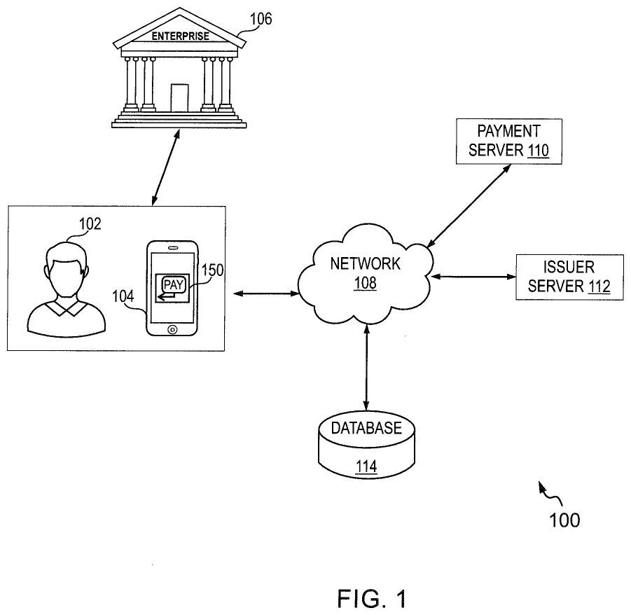

The methods and systems for classifying payment transactions into one of a personal transaction or a business transaction, is further explained in detail with reference to FIGS. 1 to 12.

FIG. 1 illustrates an example representation of an environment 100, in which at least some example embodiments of the present disclosure can be implemented. The environment 100 is depicted to include a user 102 associated with a user device 104. The user device 104 may include a smartphone, a smartwatch, a tablet, a laptop, a computer system or any computing device. It must be noted that the user device 104 is capable of receiving user inputs through swiping on a display screen of the user device 104. The user 102 may be associated with an enterprise, such as enterprise 106. The enterprise 106 may include a small or medium enterprise (SME). In an illustrative example scenario, the user 102 may use a personal payment card for purchasing goods/services. The personal payment card may include a prepaid card, a debit card, an e-wallet, a virtual payment card or a credit card that may be used for payment transactions of the user 102. The payment transactions may be related to personal expenses of the user 102 as well as business expenses of the enterprise 106.

The payment card may be issued by an issuer server, such as issuer server 112. The issuer server 112 is associated with a financial institution normally called as a “issuer bank” or an “issuing bank” or an “issuer bank” or simply an “issuer”, in which the user 102 may have the personal payment account. The issuer server 112 may issue one or more payment cards, such as a credit card or a debit card for the user 102. The user 102, being the cardholder, can use any of the payment cards to tender payment for the personal or business expenses.

In one example scenario, the user 102 may perform the payment transactions using a payment application, such as a payment application 150. The payment application 150 may be hosted by the issuer server 112. In one case, the payment application 150 may include a mobile-based application. For instance, the payment applications 150 may be downloaded by requesting the issuer server 112 and installing the payment applications 150 in the user device 104. In another case, the payment application 150 may include a web-based application that is accessible by the user 102 using the user device 104. For instance, the payment application 150 may be accessed using a web browser in the user device 104. The user 102 may initiate a payment transaction by accessing the payment application 150. After initiating the payment transaction, a payment transaction request may be sent to a payment server, such as a payment server 110. It may be noted the payment transaction request may be sent to the payment server 110 via an acquirer server (not shown in FIG. 1).

The user 102 may communicate with the issuer server 112 using a network, such as network 108. The network 108 may include wired networks, wireless networks and combinations thereof. Some non-limiting examples of the wired networks may include Ethernet, local area networks (LANs), fiber-optic networks, and the like. Some non-limiting examples of the wireless networks may include cellular networks like GSM/3G/4G/5G/LTE/CDMA networks, wireless LANs, Bluetooth, Wi-Fi or Zigbee networks, and the like. An example of the combination of wired and wireless networks may include the Internet.

In another example scenario, the user 102 may perform the payment transaction at a merchant terminal. The merchant terminal may include a Point-of-Sale (POS) terminal or an online merchant site. The payment transaction may be performed by using the payment card, such as debit/credit card of the user 102. In such scenario, the payment transaction request may be sent to an acquirer server (not shown in FIG) from the merchant terminal. The acquirer server may further transfer the payment transaction request to the payment server 110.

The payment server 110 may further transfer the payment transaction request to the issuer server 112. The issuer server 112 validates the payment transaction request and accordingly deducts a payment transaction amount from a payment account of the user 102. The deducted payment transaction amount is transferred to the payment server 110. At such point, the payment server 110 determines an occurrence of the payment transaction. The payment transaction is notified to the 102 by the issuer server 112 via the payment application 150. It must be noted that the payment server 110 may communicate with the issuer server 112 through a payment network. Examples of the payment network include, but not limited to, Mastercard® payment system interchange network. The Mastercard® payment system interchange network is a proprietary communications standard promulgated by Mastercard International Incorporated® for the exchange of financial transaction data between financial institutions that are members of Mastercard International Incorporated®. (Mastercard is a registered trademark of Mastercard International Incorporated located in Purchase, N.Y.).

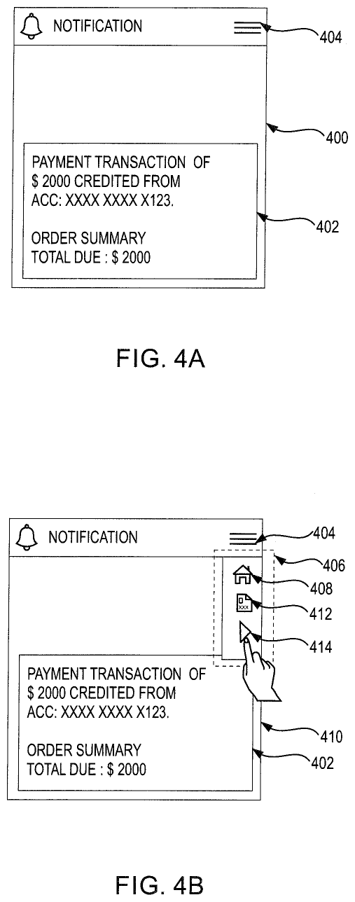

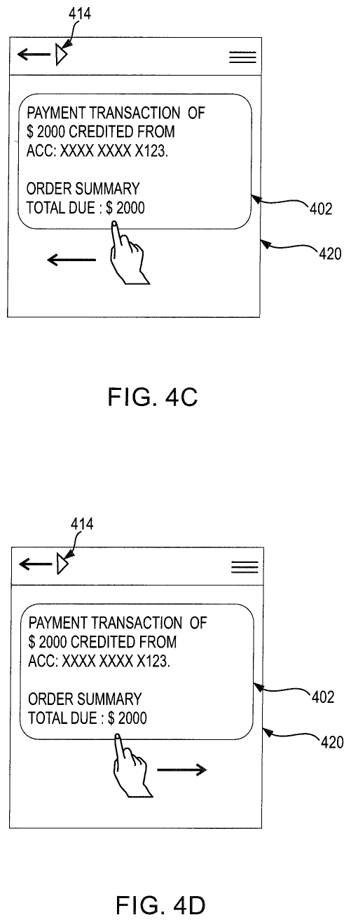

The user 102 may access the notification in the payment application 150. The user 102 may provide user input in response to the notification. Some of the examples of the user input may include, but not limited to, a touch input, a gesture input, a voice input and/or the like. In one example embodiment, the user 102 may swipe the notification to left side of screen on the user device 104, which is shown in FIG. 4C. In another example embodiment, the user 102 may swipe the notification to right side of the user device 104, which is shown in FIG. 4D. It is noted that without limiting the scope of the present disclosure, the user 102 may swipe the notification in upwards direction or downwards direction on the user device 104.

In an example embodiment, the payment server 110 may provide a plug-in module. The plug-in module may be added as a plug-in in the payment application 150, which is shown in FIG. 4B. The user 102 may trigger the plug-in module and generate an application program interface (API) call to the payment server 110. The user input may be sent to the payment server 110 via the plug-in module in the payment application 150. The payment server 110 classifies the payment transaction into one of a personal transaction or a business transaction based on the user input. In an example embodiment, the payment transaction may be classified as the personal transaction if the user input includes swiping the notification to left side of the user device 104. In alternate example embodiment, the payment transaction may be classified as the business transaction if the user input includes swiping the notification to right side of the user device 104.

Further, the classified payment transactions may be sub-classified based on one or more sub-categories. In an illustrative example scenario, the user 102 may be associated with more than one SME other than the enterprise 106 shown in FIG. 1. In such scenario, the classified payment transactions may be sub-classified according to different SMEs of the user 102. For instance, the user 102 may own SME1, SME 2 and SME 3. The user 102 may use same personal payment card for payment transactions of the SMEs, the SME 1, the SME 2 and the SME3. After classifying the payment transactions into business transactions, the business transactions may be sub-classified according to the SMEs, such as business transaction SME1, business transaction SME 2 and business transaction SME 3.

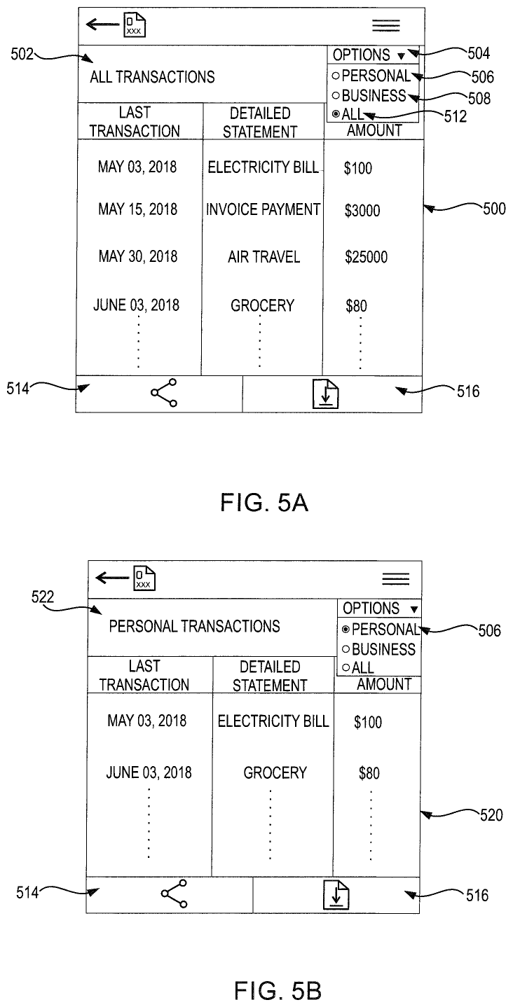

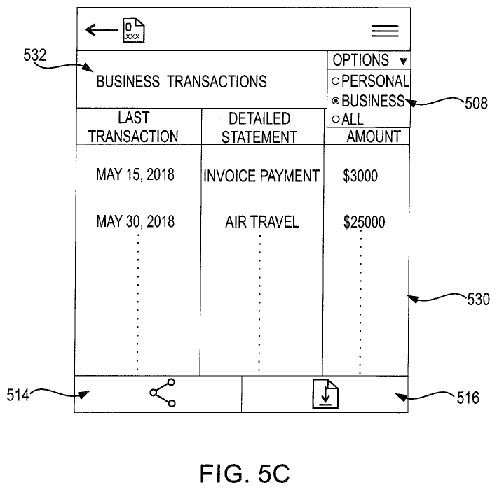

The payment server 110 sends the classified payment transaction to the issuer server 112. The issuer server 112 may store the classified payment transaction in a database, such as a database 114. It must be noted that the database 114 may be a standalone database associated with the issuer server 112 or may be embodied in the issuer server 112. The issuer server 112 may generate a segregated transaction statement based on the classified payment transaction (refer FIG. 5A). For example, the segregated transaction statement may include one of a personal transaction statement (refer FIG. 5B) and a business transaction statement (refer FIG. 5C).

The segregated transaction statement may be sent to the payment server 110. The segregated transaction statement may be generated in periodic interval or in real-time. For example, the segregated transaction statement may be generated on a daily basis (i.e., end of day) or a monthly basis (i.e., end of month) or after a payment transaction is classified. The payment server 110 may transfer the segregated transaction statement to the user 102 via the payment application 150 based on a request from the user 102 for accessing the segregated transaction statement. Also, it may be noted that there may be arrangement that the payment server 110 is capable of generating the segregated transaction statement on behalf of the issuer server 112.

The user 102 may share the segregated transaction statement to a third-party for purposes, such as tax filing, accounting, and/or the like. More specifically, the segregated transaction statement may be used for tracking the expenses that may be helpful in monitoring and managing the expenses of the user 102. The user 102 may share the segregated transaction statement as a csv file, a pdf file, or any other file format.

Further, the issuer server 112 may analyze the classified payment transactions in the database 114 for generating one or more customized plans for the user 102. In an illustrative example scenario, the user 102 may frequently use the personal payment card for booking business trips related to the enterprise 106. In such scenario, the issuer server 112 may provide a travel plan for the user 102 based on analysis of classified payment transactions. For instance, the travel plan may include a 10% cashback on booking air travel tickets for the business trips.

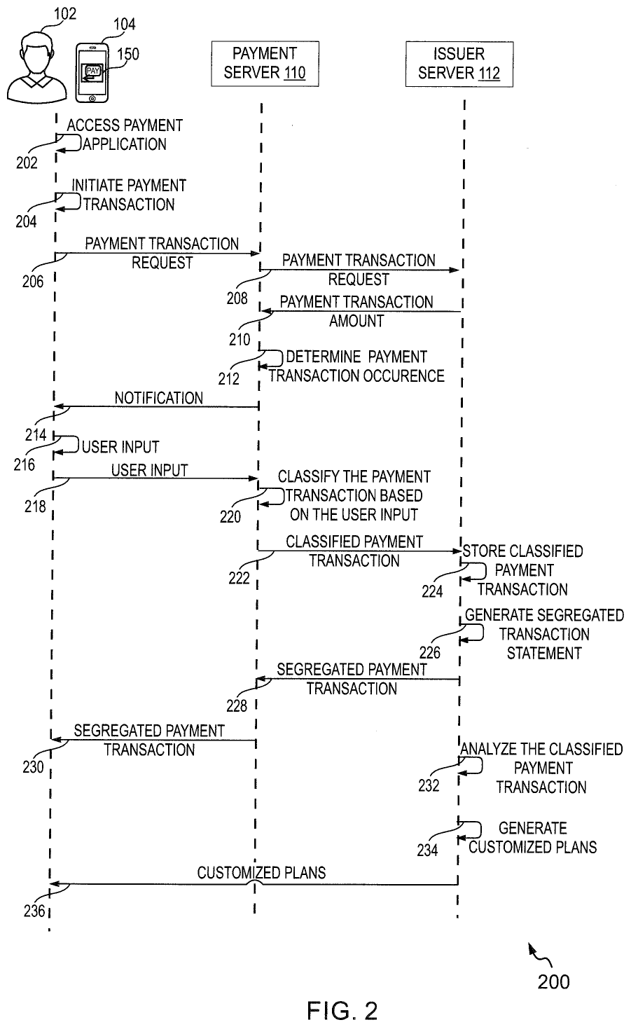

Some non-exhaustive example embodiments for classifying payment transactions into one of a personal transaction and a business transaction by a payment server, is described with reference to FIGS. 2 to 12.

FIG. 2 represents a sequence flow diagram 200 of classifying, by the payment server 110, a payment transaction performed by the user 102, in accordance with an example embodiment of the present disclosure. The payment server 110 and the user 102 are described with reference to FIG. 1. In an illustrative example scenario, the user 102 may purchase goods/services for personal or business purposes. In an example embodiment, the user 102 may perform a payment transaction for the purchased goods/services using a payment application (e.g., the payment application 150 in FIG. 1) installed in a user device (e.g., the user device 104 in FIG. 1). It must be noted that performing the payment transaction is not limited to a payment application, such as the payment application 150. The payment transaction may be performed at a merchant terminal (e.g., a POS terminal or an online merchant site) using a payment card of the user 102.

At 202, the user 102 accesses the payment application 150 in the user device 104. At 204, a payment transaction is initiated by the user 102 using the payment application 150. At 206, a payment transaction request is sent to the payment server 110. At 208, the payment server 110 further sends the payment transaction request to the issuer server 112.

At 210, the issuer server 112 sends a payment transaction amount associated with the payment transaction to the payment server 110. The payment transaction amount is deducted from a personal account of the user 102 upon successful payment authorization by the issuer server 112.

At 212, the payment server 110 determines an occurrence of a successful payment transaction. The payment server 110 determines the successful payment transaction occurrence based on receiving the payment transaction amount from the issuer server 112 post successful payment authorization.

At 214, the payment server 110 sends a notification related to the payment transaction to the user device 104. At 216, the user 102 provides a user input, via the payment application 150 installed in the user device 104, in response to the notification. In one example embodiment, the user input may be provided by triggering a plug-in module in the payment application 150. The user input may include a touch input, a voice input or a gesture input on screen of the user device 104. In an illustrative example scenario, the user 102 may provide the user input by swiping on left side or right side on screen of the user device 104. It is noted that the user 102 may also provide the user input by swiping in upwards or downwards direction, or any other pre-defined directions on the screen.

At 218, the payment application 150 sends the user input to the payment server 110. The user input is provided to the payment server 110 via the plug-in module in the payment application 150.

At 220, the payment server 110 classifies the payment transaction based on the user input. In an example embodiment, the payment transaction is classified into one of a personal transaction or a business transaction. The payment transaction may be classified into a personal transaction based on the right swipe the notification on the user device 104. Likewise, the payment transaction may be classified into a business transaction based on the left swipe of the notification on the user device 104. In an example embodiment, the payment server 110 may include pre-set flags, such as flag 0 and flag 1 for classifying the payment transaction based on the user input. For instance, if the user input is a left swipe flag 0 may be enabled and the payment transaction may be classified as a personal transaction by the payment server 110. Likewise, if the user input is a right swipe then flag 1 is enabled and the payment transaction may be classified as a business transaction.

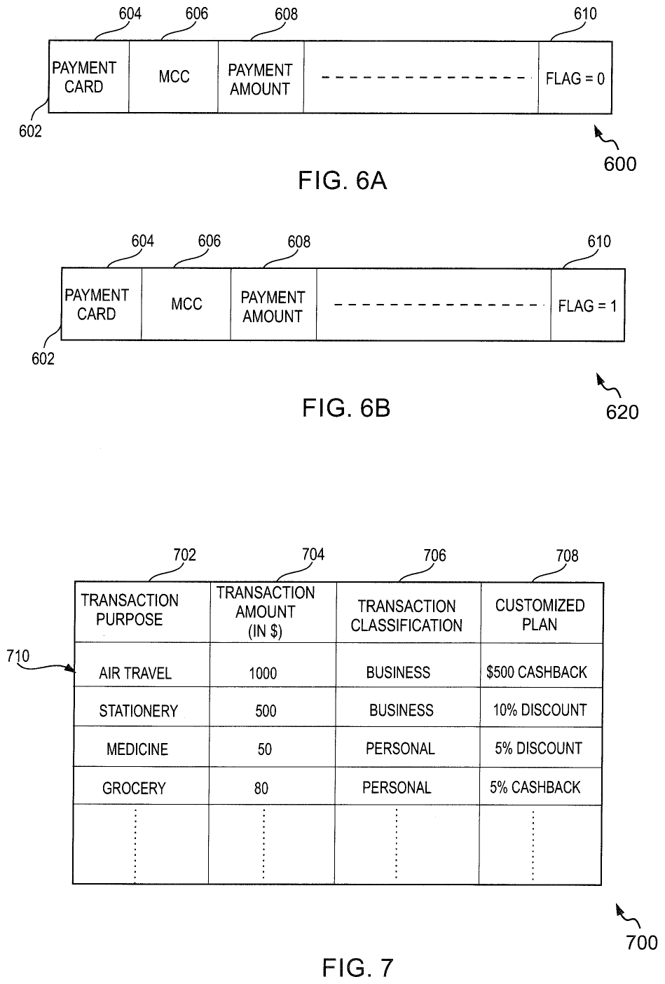

At 222, the classified payment transaction is sent to the issuer server 112 from the payment server 110. The classified payment transaction may be included in a transaction file, which is shown in FIGS. 6A and 6B.

At 224, the classified payment transaction is stored in the issuer server 112. The issuer server 112 may store the classified payment transaction in the database 114 (shown in FIG. 1).

At 226, the issuer server 112 generates a segregated transaction statement based on the classified payment transaction. At 228, the issuer server 112 sends the segregated transaction statement to the payment server 110. At 230, the payment server 110 further sends the segregated transaction statement to the user 102.

It must be noted that the segregated transaction statement may also be generated by the payment server 110 based on the classified payment transaction. For instance, the payment server 110 may receive transaction statements from the issuer server 112. These transaction statements may be segregated based on the classified payment transaction by the payment server 110.

At 232, the issuer server 112 analyzes the classified payment transaction stored in the database 114. At 234, the issuer server 112 generates customized plans for the user 102 based on the analysis of the classified payment transaction. At 236, the issuer server 112 sends the customized plans to the user 102. Once, the user 102 selects a customized plan, it can be set for the user 102.

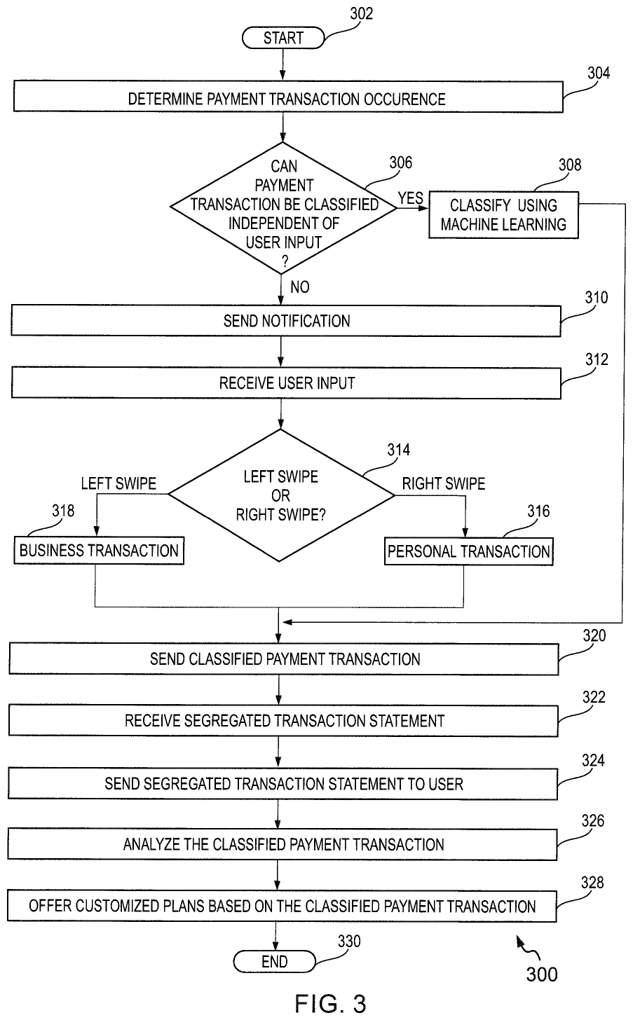

The payment transaction may be classified by the payment server 110 in independent of the user input based on learning a pattern of classification of payment transactions, which is explained next with reference to FIG. 3.

FIG. 3 represents a flowchart of a method 300 for classifying payment transactions, in accordance with another example embodiment of the present disclosure. The payment transactions may be classified independent of the user input by using machine learning techniques. The machine learning techniques may be used in learning a pattern of classification of payment transactions. The pattern may be learnt based on classification done for a pre-defined number of classified payment transactions.

At 302, classifying of payment transactions using machine learning techniques starts. At 304, an occurrence of a payment transaction is determined by the payment server 110. The payment transaction occurrence may be determined based on receiving a payment transaction from an issuer server (e.g., the issuer server 112 in FIG. 1). The payment server 110 and the issuer server 112 are described with reference to FIG. 1.

At 306, the payment server 110 checks if the payment transaction can be classified independent of the user input. In an example embodiment, artificial intelligence or machine learning techniques are used for the checking. If the payment transaction can be classified independent of the user input, the method 300 proceeds to step 308, else proceeds to step 310.

At 308, the payment transaction is classified independent of the user input using the machine learning techniques. In an example embodiment, a pattern of classification may be learnt to classify the payment transaction using the machine learning techniques. The pattern may be obtained based on learning a pre-defined number of classified payment transactions. Further, the pattern may be used to classify the payment transactions independent of the user input. In an illustrative example scenario, payment transactions related to a merchant ‘XYZ’ for purchasing employee management software and anti-virus software may be classified as business transaction. If such business transaction has been classified as business transaction for a pre-defined number of times when such payment transaction occurred for example, 7 times such payment transaction related to ‘XYZ’ merchant for purchasing employee management software and anti-virus software is classified as business transaction based on the user input, then the payment server 110 learns that a payment transaction related to the merchant XYZ for goods/services related to employee management software or the anti-virus software is a business transaction. The payment server 110 may use machine learning techniques to analyze and learn pattern of merchant name, type of goods/services purchased, or the like. The payment server 110 then classifies the payment transaction as business transaction independent of the user input.

At 310, if the payment transaction cannot be classified independent of the user input, the payment server 110 sends a notification of the payment transaction to the user 102. At 312, a user input (e.g., a touch input or a gesture input) provided in response to the notification is received. The user input may include swiping to left side or right side of the user device 104.

At 314, it is checked if the user input is a right side swipe or a left side swipe to classify the payment transaction into one of the personal transaction or the business transaction respectively. At 316, if the user input is the right side swipe, then the payment transaction is classified as personal transaction. At 318, if the user input is the left side swipe then the payment transaction is classified as business transaction.

At 320, the classified payment transaction (i.e., the personal transaction and the business transaction) is sent to the issuer server 112. At 322, a segregated transaction statement is received by the payment server 110. At 324, the segregate transaction statement is sent to the user 102 by the payment server 110.

At 326, the classified payment transactions are analyzed by the issuer server 112. At 328, customized plans are offered to the user 102 based on analysis of the classified payment. At 330, classifying of payment transactions ends.

Various embodiments of the payment application 150 provision one or more user interfaces (UIs) for facilitating classification of the payment transactions into one of a personal transaction and a business transaction. Without loss of generality, some example UIs of the payment application 150 facilitating classification of the payment transactions are shown and explained with reference to FIGS. 4A-4D and 5A-5C.

Referring now to FIG. 4A, an example representation of a UI 400 displayed to the user 102 on a display screen of a user device, such as the user device 104, for displaying a notification 402 of payment transaction in the payment application 150 is shown in accordance with an example embodiment of the present disclosure. The user device 104 and the payment application 150 are described in FIG. 1. The UI 400 is an exemplarily display of the notification 402 on the user device 104. It is noted that the notification 402 displayed is explained herein for illustration purposes and may not be considered as limiting the scope of the disclosure.

As shown in FIG. 4A, the notification 402 may include a payment transaction amount along with an order summary and a total due of the order summary. It is noted that the notification 402 is an exemplarily representation for the notification 402 without limiting the scope of the disclosure. Further, the UI 400 is depicted to exemplarily display a title associated with text ‘NOTIFICATION’ and a menu button 404. The user 102 may click on the menu button 404. The menu button 404 may include a collective list of features of the payment application 150. A plug-in module may be added in the list of features. An example UI provisioned to the user 102 for displaying the plug-in in the payment application 150 is shown in FIG. 4B.

Referring now to FIG. 4B, another example representation of a UI 410 displayed to the user 102 on a display screen of the user device 104 displaying a plug-in 414 in the payment application 150 is shown in accordance with an example embodiment of the present disclosure. As shown in FIG. 4B, the menu button 404 is depicted to exemplarily display a list of features 406. The list of features 406 may be include, but not limited to, home page tab 408, an account statement tab 412 and a plug-in tab 414. It is noted the list of features 406 displayed herein may include more tabs than shown in the FIG. 4B. The user 102 may select the plug-in tab 414. The plug-in tab 414 is triggered to receive a user input in response to the notification 402. It shall be noted that the plug-in tab 414 may also be automatically activated without selection by the user 102 based on reception of the notification by the user device 104. The user input received from the user 102 in response to the notification 402 is shown in FIGS. 4C and 4D.

With reference to FIG. 4C, the UI 420 is depicted to exemplarily display swiping the notification 402 to the left side. The user input is sent to the payment server 110 (shown in FIG. 1) via the plug-in tab 414. The payment server 110 classifies the payment transaction as personal transaction based on the user input corresponding to swiping the notification 402 to the left side. It shall be noted that the notification may be swiped to right side, which is shown in FIG. 4D.

As shown in FIG. 4D, the notification 402 is swiped to the right side. The right side swipe is sent as the user input to the payment server 110 (shown in FIG. 1). The payment server 110 may classify the payment transaction as business transaction based on the user input of right side swipe.

A segregated transaction statement may be generated by the issuer server 112 based on the classified payment transaction. The segregated transaction statement may be viewed in the payment application 150 by selecting account statement option, such as the account statement tab 412 shown in FIG. 4B. The segregated transaction statement generated based on the classified payment transaction is described with reference to FIGS. 5A-5C

Referring now to FIG. 5A, an example representation of the UI 500 displayed to the user 102 on the display screen of the user device 104 displaying transaction statements performed by the user 102 is shown in accordance with an example embodiment of the present disclosure.

As shown in FIG. 5A, the UI 500 is exemplarily depicted to display a collective account statement of all transactions 502. The all transactions 502 is depicted to include three columns, such as ‘LAST TRANSACTIONS’, ‘DETAILED STATEMENT’ and ‘AMOUNT’. The UI 500 is further depicted to include options 504. As shown in FIG. 5A, the options 504 is depicted as an exemplary drop-down list with options for selecting a personal icon 506, a business icon 508 and an all icon 512. The options 504 may include, but not limited to, user input field, search field, selection input field and click button. It is noted the options 504 displayed herein may include various other types of options than those shown in the FIG. 5A.

The account statement 502 may be shared or downloaded using icon, such as a share icon 514 and a download icon 516 The share icon 514 and the download icon 516 are displayed exemplarily at bottom of the UI 500. The share icon 514 allows the user 102 to share the transaction statements, such as the segregated transaction statements. The segregated transaction statements may be shared as a pdf file, csv file, etc. The download icon 516 allows the user 102 to download the transaction statement.

The user 102 may obtained a segregated transaction statement of only personal transaction. In an illustrative example scenario, the user 102 may select personal button 506 to obtain the segregated transaction statement of personal transaction, which is shown in FIG. 5B.

With reference to FIG. 5B, UI 520 is depicted to display a segregated statement transaction 522 of personal transactions to the user 102 based on selection of the personal icon 506. The segregated statement transaction 522 may be shared by clicking on the share icon 514 or downloaded by selecting the download icon 516. Likewise, a segregated transaction statement of only business transaction may be obtained. The user 102 may select a business icon 508 to obtain the segregated transaction statement of only business transaction, which is shown in FIG. 5C.

Referring to FIG. 5C, an example representation of a UI 530 displayed to the user 102 on a display screen of the user device 104 displaying a segregated transaction statement 532 of business transactions in accordance with an example embodiment of the present disclosure. As shown in FIG. 5C, the UI 530 is depicted to exemplarily display of the segregated transaction statement 532 based on selection of the business icon 508. The segregated transaction statement 532 may be shared through a share icon 514 or downloaded through a download icon 516.

In one example embodiment, the issuer server 112 may generate customized plans based on the classified payment transaction. The customized plans may be stored in a database, such as the database 114 shown in FIG. 1.

The classified payment transactions may be sent to the issuer server 112 in a transaction file. The transaction file may include information related to payment transaction or payment transaction classification, which is shown in FIGS. 6A and 6B.

FIG. 6A is an example representation 600 of a transaction file format 602 corresponding to a classified payment transaction sent to the issuer server 112, in accordance with an example embodiment of the present disclosure. The transaction file format 602 includes a payment card detail 604, a merchant category code (MCC) 606, a payment amount 608 and a flag 610. The transaction file format 600 herein is an exemplary representation and may include more data items than that of shown in FIG. 6A.

The payment card detail 604 may include information, such as a bank identification number (BIN), a payment card number, type of payment card (e.g., credit card or debit card) and/or the like. The BIN (i.e., the first 6-8 digits of the payment card number) is a unique identifier of a user's issuer (i.e., the issuer server 112). The payment card details 604 may include a full card number or a hashed card number, for example, 512345-XXXX-XX-1234. The MCC 606 includes a category of a merchant from whom the user (e.g., the user 102 of FIG. 1) has purchased goods/services. The payment amount 608 includes a payment transaction amount paid for the purchased goods/services. The flag 610 includes a pre-set flag (such as flag 0 or flag) of the payment server 110.

As mentioned with reference to FIG. 2, the payment server 110 may include pre-set flags, such as flag 0 and flag 1 for classifying the payment transaction based on a user input. The flag 0 may be enabled if the user input is a right swipe and the payment transaction may be classified as a personal transaction. The flag 1 is enabled if the user input is a left swipe and the payment transaction may be classified as a business transaction. In case of a personal transaction, the transaction file format 602 may include ‘FLAG=0’ in the flag 612, as shown in FIG. 6A.

FIG. 6B is another example representation 620 of the transaction file format 602 corresponding to the classified payment transaction sent to the issuer server 112, in accordance with an example embodiment of the present disclosure. In case of a business transaction, the flag 612 may be set as ‘FLAG=1’, as shown in FIG. 6B.

FIG. 7 is an example representation of a table 700 representing classified payment transactions and customized plans for a user, in accordance with an example embodiment of the present disclosure. As seen in FIG. 7, the table 700 includes classified payment transactions and customized plans for the user, such as the user 102 of FIG. 1. It shall be noted that the table 700 may include multiple such tables and each table may have more or less number of columns and rows than that of depicted in FIG. 7. The table 700 shown in FIG. 7 is exemplary and only provided for the purposes of explanation.

The table 700 includes columns representing a transaction purpose field 702, a transaction amount field 704, a transaction classification field 706 and a customized plan field 708. As an example, a row 710 depicts a payment transaction with a transaction purpose for ‘Air Travel’ and transaction amount of ‘$1000’. The row 710 under a column, transaction classification field 706 includes ‘Business’ depicting that the payment transaction of transaction amount ‘$1000’ for the transaction purpose ‘Air travel’ is classified as business transaction for the user 102. The row 710 under a column, customized plan field 708, includes a plan ‘$500 CASHBACK’. Likewise, various other payment transactions may be classified into personal transaction or business transaction and customized plans may be offered based on classified payment transactions.

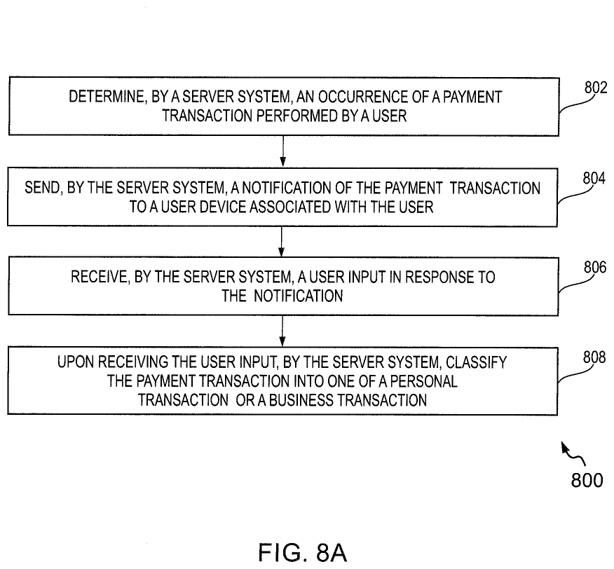

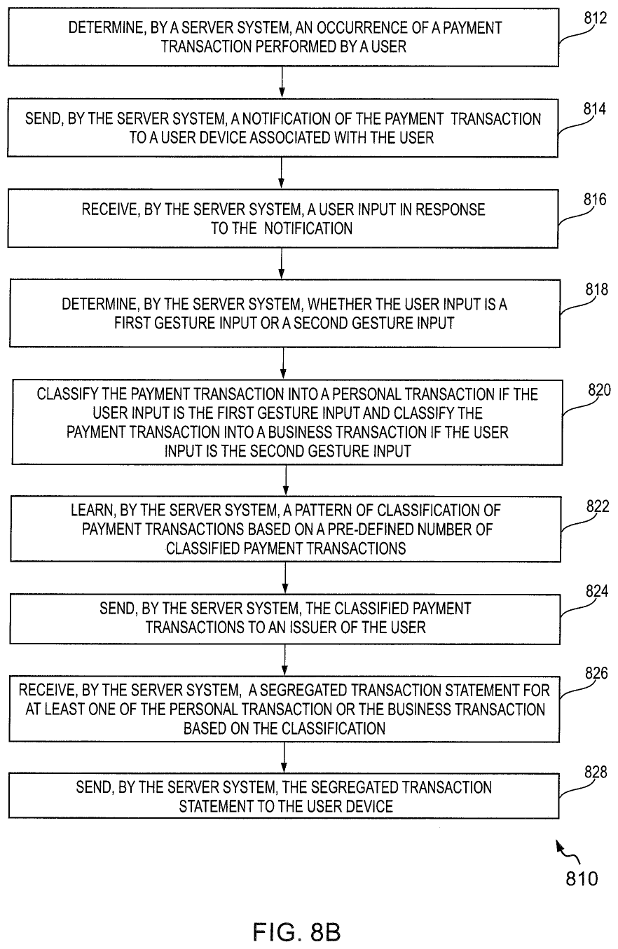

FIG. 8A illustrates a flow diagram 800 depicting a method for classifying payment transactions, in accordance with an example embodiment of the present disclosure. The method depicted in the flow diagram 800 may be executed by, for example, the payment server 110. Operations of the flow diagram 800, and combinations of operation in the flow diagram 800, may be implemented by, for example, hardware, firmware, a processor, circuitry and/or a different device associated with the execution of software that includes one or more computer program instructions. The method 800 starts at operation 802 and ends at operation 808.

At operation 802, the method 800 includes determining an occurrence of a payment transaction performed by a user. In an illustrative example scenario, a payment transaction for a purchased goods/services may be performed. In one case, the payment transaction may be performed by a user (e.g., the user 102 in FIG. 1) through a payment application (e.g., the payment application 150 in FIG. 1) in a user device (e.g., the user device 104 in FIG. 1). In another case, the payment transaction may be performed at a merchant terminal, such as POS terminal or an online merchant portal. A payment transaction request may be sent to an issuer (e.g., the issuer server 112 in FIG. 1) via the payment server 110. The issuer server 112 may process the payment transaction request and accordingly transfers a payment transaction amount to the payment server 110 from a payment account of the user 102. When the payment server 110 receives the payment transaction amount, the occurrence of the payment transaction is determined.

At operation 804, the method 800 includes sending a notification of the payment transaction to the user device 104 associated with the user 102. The notification may be sent through the payment application 150. The user 102 may open the notification in the payment application 150.

At operation 806, the method 800 includes receiving a user input in response to the notification. In at least example embodiment, the user 102 may provide the user input, such as a touch input, a gesture input, a voice input or the like in response to the notification. In a non-limiting manner, the notification may be swiped to left side or right side of the user device 104. More specifically, a plug-in module for receiving the user input may be triggered in the payment application 150. The plug-in module is provided by the payment server 110 that may be added in the payment application 150. The user input provided in response to the notification is shown in FIGS. 4A-4C.

At operation 808, the method 800 includes classifying the payment transaction into one of a personal transaction and a business transaction upon receiving the user input. The user input may be provided to the payment server 110 via the plug-in module. The payment transaction may be classified independent of the user input. In an example embodiment, a pattern of classification of payment transactions may be learned based on a pre-defined number of classified payment transactions. The pattern of classification may be learnt using machine learning techniques. Further, the pattern may be used for classifying a future payment transaction independent of the user input. Moreover, the classified payment transactions (i.e., the personal transactions and the business transactions) may be sub-classified into one or more sub-categories. The classified payment transactions may be sent to the issuer server 112. A segregated transaction statement may be generated based on the classified payment transactions. Moreover, the classified payment transactions may be analyzed by the issuer server 112 to provide customized plans for the user 102.

The sequence of operations of the method 800 need not be necessarily executed in the same order as they are presented. Further, one or more operations may be grouped together and performed in form of a single step, or one operation may have several sub-steps that may be performed in parallel or in sequential manner.

FIG. 8B illustrates a flow diagram 810 depicting a method for classifying payment transactions, in accordance with another example embodiment of the present disclosure. The method depicted in the flow diagram 810 may be executed by, for example, the payment server 110. Operations of the flow diagram 810, and combinations of operation in the flow diagram 810, may be implemented by, for example, hardware, firmware, a processor, circuitry and/or a different device associated with the execution of software that includes one or more computer program instructions. The method 810 starts at operation 812 and ends at operation 822.

At operation 812, the method 810 includes determining an occurrence of a payment transaction performed by a user.

At operation 814, the method 810 includes sending a notification of the payment transaction to a user device associated with the user.

At operation 816, the method 810 includes receiving a user input in response to the notification. The operations 812-816 are similar to operations 802-806 that are explained with reference to FIG. 8A, and therefore are not explained in detail herein again for the sake of brevity.

At operation 818, the method 810 includes determining whether the user input is a first gesture input or a second gesture input. At 820, the method 810 includes performing one of: classifying the payment transaction into a personal transaction if the user input is the first gesture input; and classifying the payment transaction into a business transaction if the user input is the second gesture input.

At operation 822, the method 810 includes learning a pattern of classification of payment transactions based on a pre-defined number of classified payment transactions. In at least an example embodiment, the pattern of classification may be learnt using machine learning techniques. The classified payment transaction, such as the personal transaction and the business transaction may further be sub-classified into one or more sub-categories.

At operation 824, the method 810 includes sending the classified payment transactions to an issuer of the user. At 826, the method 810 includes receiving a segregated transaction statement for at least one of the personal transaction or the business transaction based on the classification. At 828, the method 810 includes sending the segregated transaction statement to the user device.

The future payment transaction is classified independent of the user input based on the pattern. The classified payment transactions are sent to an issuer server (e.g., the issuer server 112). The issuer server 112 provides a segregated transaction statement for at least one of the personal transaction or the business transaction based on the classification. The segregated transaction statement is then sent to the user 102. Further, the classified payment transactions may be analyzed by the issuer server 112 to offer customized plans for the user 102.

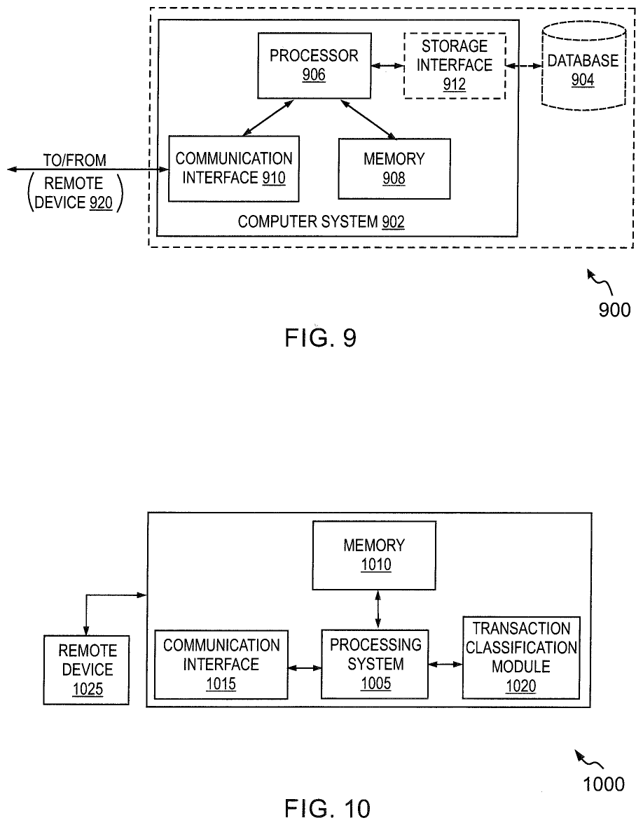

FIG. 9 is a simplified block diagram of a server system 900 used for classifying payment transactions into one of a personal transaction and a business transaction, in accordance with an embodiment of the present disclosure. The server system 900 is an example of a server (e.g., the payment server 110). The server system 900 includes a computer system 902 and a database 904.

The computer system 902 includes at least one processor 906 configured to execute executable instructions for providing various features of the present disclosure. The executing instructions are stored in a memory 908. The memory 908 may also be configured to store machine learning instructions. The components of the computer system 902 provided herein may not be exhaustive and that the computer system 902 may include more or fewer components than that of depicted in FIG. 9. Further, two or more components may be embodied in one single component, and/or one component may be configured using multiple sub-components to achieve the desired functionalities. Some components of the computer system 902 may be configured using hardware elements, software elements, firmware elements and/or a combination thereof.

The processor 906 is operatively coupled to a communication interface 910 such that computer system 902 is capable of communicating with a remote device 920, such as the user device 104, or communicating with any entity within the network 108 (shown in FIG. 1). For example, the communication interface 910 may receive a payment transaction request of a user (e.g., the user 102 in FIG. 1). Further, the communication interface 910 receives a payment transaction amount from an issuer (e.g., the issuer server 112 in FIG. 1). The communication may be achieved through API calls, without loss of generality.

The processor 906 may also be operatively coupled to the database 904. The database 904 is any computer-operated hardware suitable for storing and/or retrieving data, such as, but not limited to, user input, payment transactions along with their respective classification and associated user input, pattern of classification of the payment transactions, transaction data generated as part of sales activities conducted over the bankcard network including data relating to merchants, payees, or customers, and purchases. The database 904 may also store information related to a plurality of bank accounts of customers. Each user account data includes at least one of a cardholder name, a cardholder address, an account number, MPIN, and other account identifier. The database 904 may also include instructions for settling transactions including merchant bank account information. The database 904 may include multiple storage units such as hard disks and/or solid-state disks in a redundant array of inexpensive disks (RAID) configuration. The database 904 may include a storage area network (SAN) and/or a network attached storage (NAS) system.

In some embodiments, the database 904 is integrated within computer system 902. For example, the computer system 902 may include one or more hard disk drives as the database 904. In other embodiments, the database 904 is external to the computer system 902 and may be accessed by the computer system 902 using a storage interface 912. The storage interface 912 is any component capable of providing the processor 906 with access to the database 904. The storage interface 912 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 906 with access to the database 904.

The processor 906 is configured to determine an occurrence of a payment transaction performed by a user (e.g., the user 102). The processor 906 is further configured to perform one or more of the functions such as: send a notification of the payment transaction to the remote device 920 (i.e. the user device 104), receive a user input in response to the notification and classify the payment transaction into one of a personal transaction and a business transaction upon receiving the user input. Further, the processor 906 is configured to learn a pattern of classification of payment transactions based on a pre-defined number of classified payment transactions and classify a future payment transaction independent of the user input. The processor 906 may execute the machine learning instructions in the memory 908 to learn the pattern of classification.

FIG. 10 is a simplified block diagram of a payment server 1000 used for classifying payment transactions into one of a personal transaction and a business transaction, in accordance with an example embodiment of the present disclosure. The payment server 1000 is an example of the payment server 110 of FIG. 1. The network 108 may be used as a payment network by the payment server 1000, the server system 900 and the issuer server 1100 as a payment interchange network. Examples of payment interchange network include, but not limited to, Mastercard® payment system interchange network. The payment server 1000 includes a processing system 1005 configured to extract programming instructions from a memory 1010 to provide various features of the present disclosure. The components of the payment server 1000 provided herein may not be exhaustive and that the payment server 1000 may include more or fewer components than that of depicted in FIG. 10. Further, two or more components may be embodied in one single component, and/or one component may be configured using multiple sub-components to achieve the desired functionalities. Some components of the payment server 1000 may be configured using hardware elements, software elements, firmware elements and/or a combination thereof.

The payment server 1000 includes a processing system 1005 operatively coupled to a memory 1010, a communication interface 1015 and a transaction classification module 1020. The components of the payment server 1000 provided herein may not be exhaustive, and that the payment server 1100 may include more or fewer components than that of depicted in FIG. 10. Further, two or more components may be embodied in one single component, and/or one component may be configured using multiple sub-components to achieve the desired functionalities. Some components of the payment server 1000 may be configured using hardware elements, software elements, firmware elements and/or a combination thereof.

The memory 1010 is configured to store machine executable instructions to be accessed by the processing system 1005. Additionally, the memory 1010 stores machine learning instructions that are executed by the processing system 1005.

The communication interface 1015 is configured to receive a request corresponding to a payment transaction from a remote device 1025, such as the user device 104. More specifically, the communication interface 1015 is configured to receive a payment transaction request performed by the user 102. The request is provided to the processing system 1005 via the communication interface 1015. Further, the communication interface 1015 is configured to receive a payment transaction amount from the issuer server 112 corresponding to the payment transaction request. The communication may be achieved through API calls, without loss of generality.

The processing system 1005 is configured to determine an occurrence of a payment transaction performed by the user 102. The processing system 1005 is further configured to send a notification of the payment transaction to the remote device 1025. The notification is sent based on determining the occurrence of the payment transaction.

The communication interface 1015 is configured to receive a user input in response to the notification. The transaction classification module 1020 receives the user input via the communication interface 1015. The transaction classification module 1020 is configured to classify the payment transaction into a personal transaction or a business transaction based on the user input. In an example embodiment, the transaction classification module 1020 may include pre-set flags, such as flag 0 and flag 1 to classify the payment transaction based on the user input (e.g., left swipe or right swipe of the notification in user device 104). For instance, flag 0 classifies the payment transaction as personal transaction if the user input includes a left swipe and flag 1 classifies the payment transaction as business transaction if the user input includes a right swipe.

The transaction classification module 1020 is further configured to classify the payment transactions independent of the user input. More specifically, the transaction classification module 1020 may execute the machine learning instructions in the memory 1010 to learn a pattern of classification of the payment transactions based on a pre-defined number of classified payment transactions. The transaction classification module 1020 is configured to classify future payment transactions independent of the user input based on the pattern.

The communication interface 1015 is configured to send the classified payment transaction to the remote device 1025 (e.g., the issuer server 112). Further, the communication interface 1015 is configured to receive a segregated transaction statement from the issuer server 112. The segregated transaction statement is provided to the remote device 1025 via the communication interface 1015.

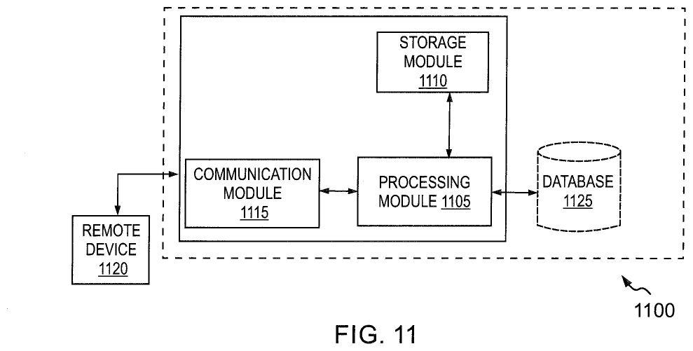

FIG. 11 is a simplified block diagram of an issuer server 1100 used for facilitating payment transactions of users, in accordance with an example embodiment of the present disclosure. The issuer server 1100 is an example of the issuer server 112 of FIG. 1, or may be embodied in the issuer server 112. The issuer server 1100 is associated with an issuer bank/issuer, in which a user (e.g., the user 102) may have an account, which provides a payment card. The issuer server 1100 includes a processing module 1105 operatively coupled to a storage module 1110 and a communication module 1115. The components of the issuer server 1100 provided herein may not be exhaustive and that the issuer server 1100 may include more or fewer components than that of depicted in FIG. 11. Further, two or more components may be embodied in one single component, and/or one component may be configured using multiple sub-components to achieve the desired functionalities. Some components of the issuer server 1100 may be configured using hardware elements, software elements, firmware elements and/or a combination thereof.

The storage module 1110 is configured to store machine executable instructions to be accessed by the processing module 1105. Additionally, the storage module 1110 stores information related to, contact information of the user, bank account number, availability of funds in the account, payment card details, transaction details and/or the like. Further, the storage module 1110 is configured to store classified payment transactions.

The processing module 1105 is configured to communicate with one or more remote devices such as a remote device 1120 using the communication module 1115 over a network such as the network 108 of FIG. 1. The examples of the remote device 1120 include the user device 104, the payment server 110 or other computing systems of issuer server 1100 and the network 108 and the like. The communication module 1115 is capable of facilitating such operative communication with the remote devices and cloud servers using API (Application Program Interface) calls. The communication module 1115 is configured to receive a payment transaction request performed by the user 102 via the network 108. The processing module 1105 receives a payment card information, a payment transaction amount, a customer information and merchant information from the merchant interface 106 in remote device 1120 (i.e. the user device 104 or the payment server 110). The issuer server 1100 includes a database 1125 for storing classified payment transactions received from the payment server 1000, segregated transaction statements and customized plans of the user 102 generated by the processing module 1005 based on the classified payment transactions.

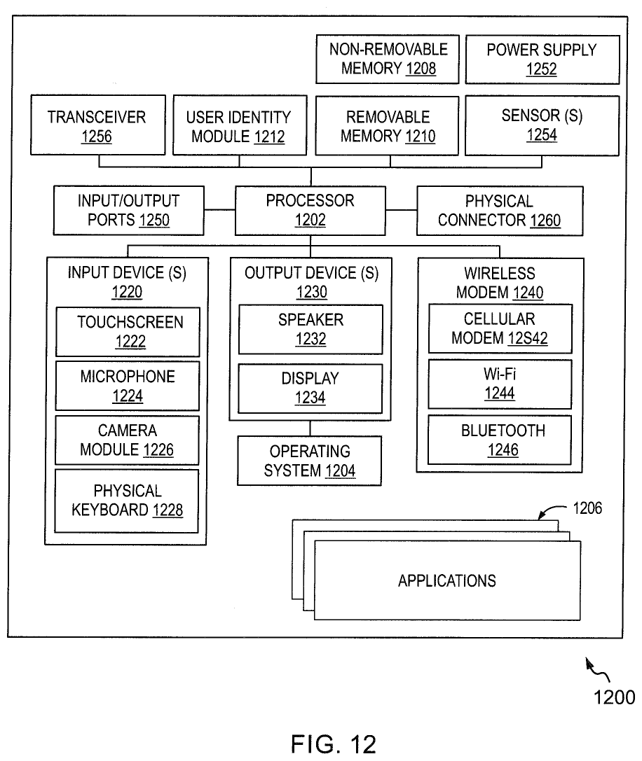

FIG. 12 shows simplified block diagram of a user device 1200, for example, a mobile phone capable of implementing the various embodiments of the present disclosure. The user device 1200 is depicted to include one or more applications 1206. The user device 1200 is an example of the user device 104.

It should be understood that the user device 1200 as illustrated and hereinafter described is merely illustrative of one type of device and should not be taken to limit the scope of the embodiments. As such, it should be appreciated that at least some of the components described below in connection with that the user device 1200 may be optional and thus in an example embodiment may include more, less or different components than those described in connection with the example embodiment of the FIG. 12. As such, among other examples, the user device 1200 could be any of an electronic device, for example, cellular phones, tablet computers, laptops, mobile computers, personal digital assistants (PDAs), mobile televisions, mobile digital assistants, or any combination of the aforementioned, and other types of communication or multimedia devices.

The illustrated user device 1200 includes a controller or a processor 1202 (e.g., a signal processor, microprocessor, ASIC, or other control and processing logic circuitry) for performing such tasks as signal coding, data processing, image processing, input/output processing, power control, and/or other functions. An operating system 1204 controls the allocation and usage of the components of the user device 1200 and support for one or more applications programs (see, applications 1206), such as payment application 150 for facilitating payment transactions of a user (e.g., the user 102 of FIG. 1), receiving a notification of the payment transactions or sending a user input in response to the notification by swiping the notification to left side or right side in the user device 104.

In addition to the application interface, the applications 1206 may include common mobile computing applications (e.g., telephony applications, email applications, calendars, contact managers, web browsers, messaging applications such as USSD messaging or SMS messaging or SIM Tool Kit (STK) application) or any other computing application.

The illustrated user device 1200 includes one or more memory components, for example, a non-removable memory 1208 and/or a removable memory 1210. The non-removable memory 1208 and/or the removable memory 1210 may be collectively known as database in an embodiment. The non-removable memory 1208 can include RAM, ROM, flash memory, a hard disk, or other well-known memory storage technologies. The removable memory 1210 can include flash memory, smart cards, or a Subscriber Identity Module (SIM). The one or more memory components can be used for storing data and/or code for running the operating system 1204 and the applications 1206. The user device 1200 may further include a user identity module (UIM) 1212. The UIM 1212 may be a memory device having a processor built in. The UIM 1212 may include, for example, a subscriber identity module (SIM), a universal integrated circuit card (UICC), a universal subscriber identity module (USIM), a removable user identity module (R-UIM), or any other smart card. The UIM 1212 typically stores information elements related to a mobile subscriber. The UIM 1212 in form of the SIM card is well known in Global System for Mobile Communications (GSM) communication systems, Code Division Multiple Access (CDMA) systems, or with third-generation (3G) wireless communication protocols such as Universal Mobile Telecommunications System (UMTS), CDMA9000, wideband CDMA (WCDMA) and time division-synchronous CDMA (TD-SCDMA), or with fourth-generation (4G) wireless communication protocols such as LTE (Long-Term Evolution).

The user device 1200 can support one or more input devices 1220 and one or more output devices 1230. Examples of the input devices 1220 may include, but are not limited to, a touch screen/a screen 1222 (e.g., capable of capturing finger tap inputs, finger gesture inputs, multi-finger tap inputs, multi-finger gesture inputs, or keystroke inputs from a virtual keyboard or keypad), a microphone 1224 (e.g., capable of capturing voice input), a camera module 1226 (e.g., capable of capturing still picture images and/or video images) and a physical keyboard 1228. Examples of the output devices 1230 may include, but are not limited to a speaker 1232 and a display 1234. Other possible output devices can include piezoelectric or other haptic output devices. Some devices can serve more than one input/output function. For example, the touch screen 1222 and the display 1234 can be combined into a single input/output device.

A wireless modem 1240 can be coupled to one or more antennas (not shown in the FIG. 12) and can support two-way communications between the processor 1202 and external devices, as is well understood in the art. The wireless modem 1240 is shown generically and can include, for example, a cellular modem 1242 for communicating at long range with the mobile communication network, a Wi-Fi compatible modem 1244 for communicating at short range with an external Bluetooth-equipped device or a local wireless data network or router, and/or a Bluetooth-compatible modem 1246. The wireless modem 1240 is typically configured for communication with one or more cellular networks, such as a GSM network for data and voice communications within a single cellular network, between cellular networks, or between the user device 1200 and a public switched telephone network (PSTN).

The user device 1200 can further include one or more input/output ports 1250 for establishing connection with peripheral devices including a power supply 1252, one or more sensors 1254 for example, an accelerometer, a gyroscope, a compass, or an infrared proximity sensor for detecting the orientation or motion of the user device 1200 and biometric sensors for scanning biometric identity of an authorized user, a transceiver 1256 (for wirelessly transmitting analog or digital signals) and/or a physical connector 1260, which can be a USB port, IEEE 1294 (FireWire) port, and/or RS-232 port. The illustrated components are not required or all-inclusive, as any of the components shown can be deleted and other components can be added.

With the application (see, the applications 1206) and/or other software or hardware components, the user device 1200 can implement the technologies described herein. For example, the processor 1202 can cause generation of one or more UIs for displaying receiving of notification of payment transaction, receiving a user input in response to the notification, such as swiping the notification to left side or right side on the touch screen 1222 of the user device 1200 and receiving a segregated transaction statement based on the classified payment transactions.

Without limiting the scope of the present disclosure, the one or more example embodiments disclosed herein is to provide methods and systems for classifying payment transactions. More specifically, the payment transactions may be classified into one of a personal transaction or a business transaction. The classified payment transactions enable generation of a segregated transaction statement in an efficient manner. The segregated transaction statement may be advantageous to users as manual organization of transaction statements may be precluded. The users may use the segregated transaction statement for tracking expenses that may be helpful in monitoring and managing the expenses. Moreover, issuers may offer customized plans to the users based on the segregated transaction statement. More specifically, the issuers may offer customized plans related to business expenses of the users. In this manner, it may be advantageous for the issuers as more users may be gained and thereby reputation and revenue of the issuers may be improved.

The disclosed methods with reference to FIGS. 1 to 12, or one or more operations of the flow diagram 800 and the flow diagram 810 may be implemented using software including computer-executable instructions stored on one or more computer-readable media (e.g., non-transitory computer-readable media, such as one or more optical media discs, volatile memory components (e.g., DRAM or SRAM), or nonvolatile memory or storage components (e.g., hard drives or solid-state nonvolatile memory components, such as Flash memory components) and executed on a computer (e.g., any suitable computer, such as a laptop computer, net book, Web book, tablet computing device, smart phone, or other mobile computing device). Such software may be executed, for example, on a single local computer or in a network environment (e.g., via the Internet, a wide-area network, a local-area network, a remote web-based server, a client-server network (such as a cloud computing network), or other such network) using one or more network computers. Additionally, any of the intermediate or final data created and used during implementation of the disclosed methods or systems may also be stored on one or more computer-readable media (e.g., non-transitory computer-readable media) and are considered to be within the scope of the disclosed technology. Furthermore, any of the software-based embodiments may be uploaded, downloaded, or remotely accessed through a suitable communication means. Such suitable communication means include, for example, the Internet, the World Wide Web, an intranet, software applications, cable (including fiber optic cable), magnetic communications, electromagnetic communications (including RF, microwave, and infrared communications), electronic communications, or other such communication means.

Although the disclosure has been described with reference to specific exemplary embodiments, it is noted that various modifications and changes may be made to these embodiments without departing from the broad spirit and scope of the disclosure. For example, the various operations, blocks, etc., described herein may be enabled and operated using hardware circuitry (for example, complementary metal oxide semiconductor (CMOS) based logic circuitry), firmware, software and/or any combination of hardware, firmware, and/or software (for example, embodied in a machine-readable medium). For example, the apparatuses and methods may be embodied using transistors, logic gates, and electrical circuits (for example, application specific integrated circuit (ASIC) circuitry and/or in Digital Signal Processor (DSP) circuitry).

Particularly, the server system 900 (e.g. payment server 110) and its various components such as the computer system 902 and the database 904 may be enabled using software and/or using transistors, logic gates, and electrical circuits (for example, integrated circuit circuitry such as ASIC circuitry). Various embodiments of the disclosure may include one or more computer programs stored or otherwise embodied on a computer-readable medium, wherein the computer programs are configured to cause a processor or computer to perform one or more operations. A computer-readable medium storing, embodying, or encoded with a computer program, or similar language, may be embodied as a tangible data storage device storing one or more software programs that are configured to cause a processor or computer to perform one or more operations. Such operations may be, for example, any of the steps or operations described herein. In some embodiments, the computer programs may be stored and provided to a computer using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g. magneto-optical disks), CD-ROM (compact disc read only memory), CD-R (compact disc recordable), CD-R/W (compact disc rewritable), DVD (Digital Versatile Disc), BD (BLU-RAY® Disc), and semiconductor memories (such as mask ROM, PROM (programmable ROM), EPROM (erasable PROM), flash memory, RAM (random access memory), etc.). Additionally, a tangible data storage device may be embodied as one or more volatile memory devices, one or more non-volatile memory devices, and/or a combination of one or more volatile memory devices and non-volatile memory devices. In some embodiments, the computer programs may be provided to a computer using any type of transitory computer readable media. Examples of transitory computer readable media include electric signals, optical signals, and electromagnetic waves. Transitory computer readable media can provide the program to a computer via a wired communication line (e.g. electric wires, and optical fibers) or a wireless communication line.

Various embodiments of the disclosure, as discussed above, may be practiced with steps and/or operations in a different order, and/or with hardware elements in configurations, which are different than those which, are disclosed. Therefore, although the disclosure has been described based upon these exemplary embodiments, it is noted that certain modifications, variations, and alternative constructions may be apparent and well within the spirit and scope of the disclosure.

Although various exemplary embodiments of the disclosure are described herein in a language specific to structural features and/or methodological acts, the subject matter defined in the appended claims is not necessarily limited to the specific features or acts described above. Rather, the specific features and acts described above are disclosed as exemplary forms of implementing the claims.

What is claimed is:

1. A method, comprising:
determining, by a server system, an occurrence of a payment transaction performed by a user;
sending, by the server system, a notification of the payment transaction to a user device associated with the user;
receiving, by the server system, a user input in response to the notification; and
classifying, upon receiving the user input by the server system, the payment transaction into one of a personal transaction or a business transaction.

2. The method of claim 1, further comprising:
learning, by the server system, a pattern of classification of payment transactions based on a pre-defined number of classified payment transactions; and
classifying, by the server system, a future payment transaction independent of the user input based on the pattern learned by the server system.

3. The method of claim 1, further comprising:
sending, by the server system, the classified payment transactions to an issuer associated with the user;
receiving, by the server system, a segregated transaction statement for at least one of the personal transaction or the business transaction based on the classified payment transactions; and
sending, by the server system, the segregated transaction statement to an application available in the user device.

4. The method of claim 3, wherein the classified payment transactions are analyzed by the issuer to offer one or more customized plans for the user.

5. The method of claim 1, wherein the user input comprises at least:
a touch input; and
a gesture input.

6. The method of claim 5, wherein the user input corresponds to at least one of:
swiping to left side within an application on a screen of the user device; and
swiping to right side within the application on the screen.

7. The method of claim 6, wherein the payment transaction is classified into the personal transaction based on the user input corresponding to swiping to the right side on the screen, and wherein the payment transaction is classified into the business transaction based on the user input corresponding to swiping to the left side on the screen.

8. The method of claim 1, wherein classifying the payment transaction further comprises:
sub-classifying the personal transaction into one or more sub-categories; and
sub-classifying the business transaction into one or more sub-categories.

9. The method of claim 1, wherein the notification is sent to an application available in the user device, and wherein the user input in response to the notification is received through the application.

10. A server system, comprising:
a memory storing executable instructions; and
a processor in operative communication with the memory, the processor configured to execute the instructions to cause the server system to at least:
determine an occurrence of a payment transaction performed by a user,
send a notification of the payment transaction to an application in a user device associated with the user,
receive a user input through the application in response to the notification, and
classify the payment transaction into one of a personal transaction or a business transaction upon receiving the user input.

11. The server system of claim 10, wherein the processor is further configured to execute the instructions to cause the server system to at least:
learn a pattern of classification of payment transactions based on a pre-defined number of classified payment transactions; and
classify a future payment transaction independent of the user input based on the pattern learned by the server system.

12. The server system of claim 10, wherein the processor is further configured to execute the instructions to cause the server system to at least:
send the classified payment transactions to an issuer associated with the user;
receive a segregated transaction statement for at least one of the personal transaction or the business transaction based on the classified payment transactions; and
send the segregated transaction statement to the user device.

13. The server system of claim 12, wherein the classified payment transactions is analyzed by the issuer to offer one or more customized plans for the user.

14. The server system of claim 10, wherein the user input comprises at least:
a touch input; and
a gesture input.

15. The server system of claim 14, wherein the user input corresponds to at least one of:
swiping to left side within the application on a screen of the user device; and
swiping to right side within the application on the screen.

16. The server system of claim 15, wherein the payment transaction is classified into the personal transaction based on the user input corresponding to swiping to the right side on the screen, and wherein the payment transaction is classified into the business transaction based on the user input corresponding to swiping to the left side on the screen.

17. The server system of claim 10, wherein the server system is further caused at least in part to:
sub-classify the personal transaction into one or more sub-categories; and
sub-classify the business transaction into one or more sub-categories.

18. A method for classifying a payment transaction, the method comprising:
determining, by a server system, an occurrence of a payment transaction performed by a user;
sending, by the server system, a notification of the payment transaction to a user device associated with the user;
receiving, by the server system, a user input in response to the notification;
determining, by the server system, whether the user input is a first gesture input or a second gesture input;
performing, by the server system, one of
upon determining the user input as the first gesture input, classifying, by the server system, the payment transaction into a personal transaction, and
upon determining the user input as the second gesture input, classifying, by the server system, the payment transaction into a business transaction; and
learning, by the server system, a pattern of classification of payment transactions based on a pre-defined number of classified payment transactions,
wherein a future payment transaction is classified by the server system independent of the user input based on the pattern learned by the server system;
sending, by the server system, the classified payment transactions to an issuer of the user;
receiving, by the server system, a segregated transaction statement for at least one of the personal transaction or the business transaction based on the classification; and
sending, by the server system, the segregated transaction statement to the user device.

19. The method of claim 18, wherein the notification is sent to an application available in the user device, and wherein the user input in response to the notification is received through the application.

20. The method of claim 18, wherein the classified payment transactions is analyzed by the issuer to offer one or more customized plans for the user.
